(19) United States
(12) Patent Application Publication
(10) Pub. No.: US 2021/0115280 A1
(43) Pub. Date: Apr. 22, 2021

(54) AQUEOUS INK OR LACQUER COMPOSITION FOR COATING OR PRINTING A SUBSTRATE

(71) Applicant: Marabu GmbH & Co. KG, Tamm (DE)

(72) Inventors: Stefan Engel, Rückersdorf (DE); Jochen Sommerluksch, Owen (DE); Regina Zelbel, Magstadt (DE); Rabia Kücük, Vaihingen/Enz (DE)

(21) Appl. No.: 17/071,242

(22) Filed: Oct. 15, 2020

(30) Foreign Application Priority Data
Oct. 17, 2019 (DE) 102019216004.2

(51) Int. Cl. C09D 11/107; C09D 11/322; C09D 11/40; C09D 11/102; C09D 133/08; B41M 5/00

(52) U.S. Cl. CPC C09D 11/107; C09D 11/322; B41M 5/0023; C09D 11/102; C09D 133/08; C09D 11/40

(57) ABSTRACT

An aqueous ink or lacquer composition, in particular for coating or printing a substrate, including at least one thickener, at least one binder, at least one solvent and water, wherein the at least one thickener is at least one associative thickener, and the at least one binder is a compound which differs from the at least one associative thickener and is selected from the group consisting of polyacrylate, urethane acrylate, polyurethane, acrylonitrile-butadiene rubber (NBR), acrylonitrile-butadiene-styrene rubber (ABS), methacrylate-butadiene-styrene (MBS), methyl methacrylate-butadiene-styrene (MBS), and mixtures of at least two of the binders mentioned.

### TECHNICAL FIELD

This disclosure relates to an aqueous ink or lacquer composition, in particular for coating or printing a substrate, to a method of coating or printing a substrate, to a substrate at least partially coated or printed with the ink or lacquer composition, to an ink set and also to the use of the aqueous ink or lacquer composition for coating and/or printing a substrate.

### BACKGROUND

What are known as thickeners are generally employed to adjust the viscosity of aqueous ink compositions. Corresponding ink compositions are known, for example, from EP 2 046 902 B1 and DE 602 15 508 T2.

It is disadvantageous that a perceptible influencing of the viscosity of aqueous ink compositions requires working with large amounts of thickener. This generally leads to a negative impact on the properties of the ink compositions. For example, a high proportion of thickener can result in deterioration in the start-up performance of printheads as a result of deposits of the ink compositions on the printheads, and in the ink compositions having a reduced abrasion resistance on a coated or printed substrate.

To counteract the disadvantages described above, the ink compositions often have a high proportion of organic solvents. However, this often leads to an increase in the drying times for the ink compositions. In addition, high proportions of organic solvents are also increasingly undesirable from environmental standpoints.

It could therefore be helpful to provide an aqueous ink or lacquer composition that at least to some extent avoids disadvantages known in relation to conventional aqueous ink or lacquer compositions and a method of coating or printing a substrate, a substrate at least partially coated with the aqueous ink or lacquer composition, an ink set, and a use of the aqueous ink or lacquer composition.

### SUMMARY

We provide an aqueous ink or lacquer composition for coating or printing a substrate including at least one thickener, at least one binder, at least one organic solvent, and water, wherein the at least one thickener is at least one associative thickener, and the at least one binder is a compound different from the at least one associative thickener and is selected from the group consisting of polyacrylate, urethane acrylate, polyurethane, acrylonitrile-butadiene rubber (NBR), acrylonitrile-butadiene-styrene rubber (ABS), methacrylate-butadiene-styrene (MBS), methyl methacrylate-butadiene-styrene and mixtures thereof.

We also provide a method of coating, printing or digitally printing a substrate including coating, printing or digitally printing a surface of a substrate with the aqueous ink or lacquer composition for coating or printing a substrate including at least one thickener, at least one binder, at least one organic solvent, and water, wherein the at least one thickener is at least one associative thickener, and the at least one binder is a compound different from the at least one associative thickener and is selected from the group consisting of polyacrylate, urethane acrylate, polyurethane, acrylonitrile-butadiene rubber (NBR), acrylonitrile-butadiene-styrene rubber (ABS), methacrylate-butadiene-styrene (MBS), methyl methacrylate-butadiene-styrene and mixtures thereof.

We further provide an ink set including one or more of the ink compositions for coating or printing a substrate including at least one thickener, at least one binder, at least one organic solvent, and water, wherein the at least one thickener is at least one associative thickener, and the at least one binder is a compound different from the at least one associative thickener and is selected from the group consisting of polyacrylate, urethane acrylate, polyurethane, acrylonitrile-butadiene rubber (NBR), acrylonitrile-butadiene-styrene rubber (ABS), methacrylate-butadiene-styrene (MBS), methyl methacrylate-butadiene-styrene and mixtures thereof, wherein the ink compositions differ from each other at least with respect to a colorant, a dye and/or a pigment.

### DETAILED DESCRIPTION

We provide an aqueous ink or lacquer composition, in particular for coating or printing, preferably digitally printing, a substrate, in particular a substrate surface.

The substrate can, for example, comprise or consist of a material selected from the group consisting of polyvinyl chloride, polymethyl methacrylate, polyamide, polypropylene, polyethylene, acrylonitrile-butadiene-styrene copolymer, polystyrene, copolymers of at least two of the materials mentioned and blends, i.e., mixtures, of at least two of the materials mentioned.

The substrate is preferably a film, in particular a foodstuff packaging film. Alternatively, the substrate may, for example, be paper, a cardboard packaging or a wallpaper.

The aqueous ink or lacquer composition comprises the following:
at least one thickener,
at least one binder,
at least one organic solvent and
water.

The at least one thickener is at least one associative thickener.

The at least one binder is a compound that differs from the at least one thickener, or rather at least one associative thickener, and is selected from the group consisting of polyacrylate, urethane acrylate, polyurethane, acrylonitrile-butadiene rubber (NBR), acrylonitrile-butadiene-styrene rubber (ABS), methacrylate-butadiene-styrene (MBS), methyl methacrylate-butadiene-styrene, and mixtures of at least two of the binders mentioned.

In particular, the at least one binder can be a polyacrylate which differs from the at least one thickener, or rather the associative thickener.

The expression “aqueous ink composition” means an aqueous, i.e., water-comprising, solution or an aqueous, i.e., water-comprising, dispersion comprising at least one colorant, in particular at least one dye and/or at least one pigment. Regarding suitable colorants, in particular suitable pigments and/or dyes, reference is made to the statements made hereinbelow.

The expression “aqueous lacquer composition” means an aqueous coating composition that in particular is applied to a substrate for protective purposes (so-called protective lacquer) and/or for decorative purposes (optical effect and/or particular color effect) and/or for functional purposes (such as, for example, particular surface properties and/or modified electrical conductivity).

The expression “thickener” means a compound that is able to bind unbound water, in particular while/by swelling, in particular only while/by swelling.

The expression “associative thickener” means a thickener the molecules of which, generally macromolecules, have hydrophobic and hydrophilic ends and/or hydrophobic and hydrophilic side chains.

The expression “binder” means a compound that on the one hand binds the constituents of the ink or lacquer composition to one another and on the other hand promotes adhesion to a substrate, in particular to a surface of a substrate.

The expression “acrylonitrile-butadiene rubber (NBR)” means a copolymer having acrylonitrile structural elements and 1,3-butadiene structural elements, or consists of acrylonitrile structural elements and 1,3-butadiene structural elements. The acrylonitrile structural elements and/or 1,3-butadiene structural elements may be modified, in particular functionalized. For example, the acrylonitrile structural elements and/or 1,3-butadiene structural elements can be modified, in particular functionalized, with carboxyl groups and/or substituents comprising carboxyl groups. The acrylonitrile structural elements and/or 1,3-butadiene structural elements can alternatively be unmodified. Suitable acrylonitrile-butadiene rubbers (NBR) are, for example, carboxyl-acrylonitrile-butadiene copolymers from the manufacturers Zeon Corporation (Nipol series), from Emerald Materials (Nychem series) and from Synthomer (Litex series).

The expression “acrylonitrile-butadiene-styrene rubber (ABS)” means a terpolymer having acrylonitrile structural elements, butadiene structural elements and styrene structural elements, or consists of acrylonitrile structural elements, butadiene structural elements and styrene structural elements. The acrylonitrile-butadiene-styrene rubber (ABS) is preferably a thermoplastic terpolymer in which side chains formed from styrene-acrylonitrile copolymers (SAN) are covalently attached to a polybutadiene-based main chain. The acrylonitrile structural elements and/or butadiene structural elements and/or styrene structural elements may be modified, in particular functionalized. For example, the acrylonitrile structural elements and/or butadiene structural elements and/or styrene structural elements can be modified, in particular functionalized, with carboxyl groups and/or substituents comprising carboxyl groups. The acrylonitrile structural elements and/or butadiene structural elements and/or styrene structural elements can alternatively be unmodified. Suitable acrylonitrile-butadiene-styrene rubbers (ABS) are, for example, carboxylated acrylonitrile-butadiene-styrene copolymers from Emerald Materials (Nychem series) and Synthomer (Litex series).

The expression “methacrylate-butadiene-styrene (NBS)” means a copolymer having methacrylate structural elements and butadiene structural elements, or consists of methacrylate structural elements and butadiene structural elements. The methacrylate structural elements and/or butadiene structural elements may be modified, in particular functionalized. For example, the methacrylate structural elements and/or butadiene structural elements can be modified, in particular functionalized, with carboxyl groups and/or substituents comprising carboxyl groups. The methacrylate structural elements and/or butadiene structural elements can alternatively be unmodified. Suitable methacrylate-butadiene-styrene copolymers are, for example, carboxylated methacrylate-butadiene-styrene copolymers of the Litex series from Synthomer.

The expression “methyl methacrylate-butadiene-styrene” means a copolymer or rubber having methyl methacrylate structural elements, butadiene structural elements and styrene structural elements, or which consists of methyl methacrylate structural elements, butadiene structural elements and styrene structural elements. The methyl methacrylate structural elements and/or butadiene structural elements and/or styrene structural elements may be modified, in particular functionalized. For example, the methyl methacrylate structural elements and/or butadiene structural elements and/or styrene structural elements can be modified, in particular functionalized, with carboxyl groups and/or substituents comprising carboxyl groups. The methyl methacrylate structural elements and/or butadiene structural elements and/or styrene structural elements can alternatively be unmodified.

We found that the combination of a thickener, or rather associative thickener, and a binder makes it possible to produce aqueous ink or lacquer compositions having a sufficient viscosity from processing points of view, without disturbing any thixotropic properties of the compositions. As a result, good printability (problem-free start-up of a printhead after downtimes, reliable droplet formation, no nozzle failures during operation) is achievable in particular.

It is also advantageous that only small amounts of thickener and binder are needed to adjust the viscosity of the aqueous ink or lacquer composition. A negative impact on desired properties of the ink or lacquer composition can be avoided as a result.

A further advantage is that, because of the combination of a thickener and binder, smaller amounts of organic solvent are necessary as a result of which, first, the drying times of the aqueous ink or lacquer composition can be considerably shortened and, second, the aqueous ink or lacquer composition is subject to reduced environmental concerns.

Furthermore, the aqueous ink or lacquer composition is also advantageous in respect of the intended coating or printing result, and in particular features high mechanical and chemical resistance, especially with respect to wet abrasion and/or dry abrasion.

A further advantage is that the binders do not, or do not significantly, alter the viscosity of the aqueous ink or lacquer composition.

Lastly, it is advantageous that a large number of different colors (color gamut) can be printed with the aqueous ink or lacquer composition.

In one configuration, the viscosity of the aqueous ink or lacquer composition rises linearly, in particular with a gradient of at least two, as the proportion of the at least one thickener, or rather of the at least one associative thickener, in the aqueous ink or lacquer composition increases.

In a further configuration, the at least one associative thickener is selected from the group consisting of hydrophobically modified polyacrylate (HASE), hydrophobically modified cellulose ether (HEC), hydrophobically modified polyacrylamide (HMPAM), hydrophobically modified polyether (HMPE), associative polyurethane thickener, and mixtures of at least two of the associative thickeners mentioned.

The aforementioned hydrophobically modified polyacrylate is preferably a hydrophobically modified alkali-soluble emulsion polymer.

In a further configuration, the at least one associative thickener, in particular the hydrophobically modified polyacrylate, is a copolymer which is prepared by polymerization, specifically copolymerization, of an anionic monomer, a hydrophobic monomer and a non-ionic monomer.

The anionic monomer can have, as polymerized units in the copolymer, carboxylate groups present in a form at least partly neutralized by ammonium ions and/or monoalkylammonium ions and/or dialkylammonium ions and/or trialkylammonium ions. An improvement in the compatibility and the incorporability of the copolymer is achievable by this.

Suitable anionic monomers for preparing the copolymer are monomers which contain a negative charge when they are present in a basic aqueous solution.

In a further configuration, the anionic monomer is selected from the group consisting of acrylic acid, methacrylic acid, crotonic acid, phosphoethyl methacrylate, 2-acrylamido-2-methyl-1-propanesulfonic acid, sodium vinylsulfonate, itaconic acid, fumaric acid, maleic acid, monomethyl itaconate, monomethyl fumarate, monobutyl fumarate, maleic anhydride, and combinations of at least two of the anionic monomers mentioned.

The anionic monomer can additionally comprise, as polymerized units, a proportion of 5% by weight to 75% by weight, in particular 10% by weight to 60% by weight, preferably 20% by weight to 50% by weight, based on the total weight of the copolymer.

In a further configuration, the hydrophobic monomer is selected from the group consisting of surface-active esters, C₈-C₃₀-alkylphenoxy(ethyleneoxy)₆₋₁₀₀ethyl acrylate, C₈-C₃₀-alkylphenoxy(ethyleneoxy)₆₋₁₀₀ethyl methacrylate, C₈-C₃₀-alkoxy(ethyleneoxy)₆₋₅₀ethyl acrylate, C₈-C₃₀-alkoxy(ethyleneoxy)₆₋₅₀ethyl methacrylate, C₈-C₃₀-alkylphenoxyethyl acrylate, C₈-C₃₀-alkylphenoxyethyl methacrylate, C₈-C₃₀-alkoxyethyl acrylate, C₈-C₃₀-alkoxyethyl methacrylate, C₁₈H₃₇(EO)₂₀ acrylate, C₁₈H₃₇(EO)₂₀ methacrylate, C₂₀H₂₅(EO)₂₃ acrylate; C₂₀H₂₅(EO)₂₃ methacrylate, and combinations of at least two of the hydrophobic monomers mentioned.

The hydrophobic monomer can additionally comprise, as polymerized units, a proportion of 1% by weight to 20% by weight, in particular 1% by weight to 15% by weight, preferably 1% by weight to 10% by weight, based on the total weight of the copolymer.

In a further configuration, the non-ionic monomer is a monomer that in aqueous solution does not contain any positive or negative charges. The non-ionic monomer preferably has a carbon chain having fewer than 8 carbon atoms.

The non-ionic monomer is preferably selected from the group consisting of C1- to C7-alkyl esters of acrylic acid, C1- to C7-alkyl esters of methacrylic acid, C2- to C7-hydroxyalkyl esters of acrylic acid, C2- to C7-hydroxyalkyl esters of methacrylic acid, ethyl acrylate, ethyl methacrylate, methyl acrylate, methyl methacrylate, 2-ethylhexyl acrylate, butyl acrylate, butyl methacrylate, 2-hydroxyethyl acrylate, 2-hydroxybutyl methacrylate, styrene, vinyltoluene, t-butylstyrene, isopropylstyrene, p-chlorostyrene, vinyl acetate, vinyl butyrate, vinyl caprolate, acrylonitrile, methacrylonitrile, butadiene, isoprene, vinyl chloride, vinylidene chloride and combinations of at least two of the non-ionic monomers mentioned.

The non-ionic monomer can additionally comprise, as polymerized units, a proportion of 30% by weight to 75% by weight, in particular 35% by weight to 70% by weight, preferably 40% by weight to 65% by weight, based on the total weight of the copolymer.

Alternatively, it may be preferable for the at least one associative thickener or hydrophobically modified polyacrylate to be an associative thickener which is commercially available under the name “BYK LP-R21675.”

In a further configuration, the at least one binder is a polyacrylate having a molar mass of ≥10 000 g/mol, in particular ≥10 000 g/mol to ≤1 000 000 g/mol, preferably ≥10 000 g/mol to ≤200 000 g/mol, particularly preferably ≥10 000 g/mol to ≤45 000 g/mol, in particular ≥25 000 g/mol to ≤35 000 g/mol.

In a further configuration, the at least one binder is a polyacrylate copolymer, in particular polyacrylate block copolymer. The at least one binder is preferably a polyacrylate or polyacrylate copolymer formed from an ester of acrylic acid (polyacrylic ester) and at least one comonomer. The ester of acrylic acid is preferably selected from the group consisting of methyl acrylate, ethyl acrylate, n-butyl acrylate, isobutyl acrylate, tert-butyl acrylate, 2-ethylhexyl acrylate, lauryl acrylate, stearyl acrylate, benzyl acrylate, and combinations of at least two of the esters of acrylic acid mentioned. The comonomer is preferably selected from the group consisting of methacrylic acid, methyl methacrylate, butyl acrylate, acrylamide, styrene, acrylonitrile, vinyl acetate, vinyl alcohol, urethane and combinations of at least two of the comonomers mentioned.

The at least one binder is preferably a binder available commercially under the name “Joncryl 538.” This is a polyacrylate having a molar mass of ≥200 000 g/mol, a viscosity (at 25° C., Brookfield) of 250 mPas, a pH of 7.7, a density (at 25° C.) of 1.05 g/cm³ and a glass transition temperature (DSC) of 64° C.

The polyurethane mentioned in connection with the at least one binder can, for example, be a polyurethane available commercially under the name NeoRez R-650. Alternatively or in combination, the polyurethane can be a polyurethane of the Takelac WS series, for example, a polyurethane available commercially under the name Takelac WS-4022. Alternatively or in combination, the polyurethane can be a polyurethane of the Takelac W series, for example, a polyurethane available commercially under the name Takelac W-5661.

The urethane acrylate mentioned in connection with the at least one binder can, for example, be a urethane acrylate available commercially under the name NeoPac E-200.

In a further configuration, the aqueous ink or lacquer composition has a ratio of the at least one binder to the at least one thickener, or rather to the at least one associative thickener, of at least 5:1, in particular 5:1 to 20:1, in particular 5:1 to 15:1, preferably 5:1 to 10:1, based on the combined solids contents of the at least one binder and of the at least one thickener (or rather of the at least one associative thickener) present in the aqueous ink or lacquer composition.

The aqueous ink or lacquer composition preferably does not comprise any further thickener aside from the thickener, or rather associative thickener. In other words, it is preferable when the at least one thickener or rather the at least one associative thickener, is the sole thickener in the aqueous ink or lacquer composition.

It is further preferable for the aqueous ink or lacquer composition not to comprise any further binder aside from our binder. In other words, it is preferable when the at least one binder is/are the sole binder(s) in the aqueous ink or lacquer composition.

The advantages come into particularly great effect when using the thickeners and binders described in the preceding paragraphs.

The aqueous ink or lacquer composition can furthermore comprise a total solids content of <12% by weight, in particular 3% by weight to 10% by weight, preferably 4% by weight to 9% by weight, based on the total weight of the aqueous ink or lacquer composition. The solids contents described in this paragraph in particular have the advantage that they do not excessively severely impair the desired properties of the aqueous ink or lacquer composition, in particular both with respect to processibility at a printhead and with respect to resistance to wet abrasion and/or dry abrasion. While high solids contents do in principle have advantageous effects on the resistance, they have disadvantageous effects on the printability of the ink or lacquer composition. Inversely, while low solids contents are advantageous with respect to printability, they are disadvantageous with respect to the resistance of the ink or lacquer composition.

The at least one thickener, or rather the at least one associative thickener, preferably comprises a proportion of 0.01% by weight to 0.5% by weight, in particular 0.03% by weight to 0.35% by weight, by preference 0.06% by weight to 0.30% by weight, based on the total weight of the aqueous ink or lacquer composition. The thickener proportions described in this paragraph in particular have the advantage that the desired properties of the aqueous ink or lacquer composition, in particular with respect to processibility at a printhead and/or resistance to wet abrasion and/or dry abrasion, are not, or are essentially not, impaired thereby.

The at least one binder by preference has a proportion of 0.1% by weight to 10% by weight, in particular 1% by weight to 5% by weight, preferably 1.1% by weight to 4.4% by weight, based on the total weight of the aqueous ink or lacquer composition. The binder proportions described in this paragraph in particular have proved to be advantageous for not excessively severely impairing desired properties of the aqueous ink or lacquer composition, in particular both with respect to processibility at a printhead and with respect to resistance to wet abrasion and/or dry abrasion. While high binder proportions are advantageous with respect to the resistance of the ink or lacquer composition, they have a disadvantageous effect on the printability of the ink or lacquer composition. Inversely, low binder proportions are advantageous with respect to printability, but they are disadvantageous with respect to the resistance of the ink or lacquer composition.

In a further configuration, the at least one thickener, or rather the at least one associative thickener, and the at least one binder together comprise a proportion of 0.1% by weight to 10% by weight, in particular 1% by weight to 5.5% by weight, preferably 1.1% by weight to 4.6% by weight, based on the total weight of the aqueous ink or lacquer composition. The total proportions disclosed in this paragraph for the at least one thickener and the at least one binder have proved to be advantageous in particular to prevent or essentially prevent negative impacts on desired properties of the aqueous ink or lacquer composition, in particular with respect to processibility at a printhead and/or resistance to wet abrasion and/or dry abrasion.

The at least one thickener, or rather the at least one associative thickener, can further have an average particle diameter of 0.01 μm to 1 μm, in particular 0.02 μm to 0.5 μm, preferably 0.05 μm to 0.2 μm.

The at least one binder can have an average particle diameter of 0.01 μm to 1 μm, in particular 0.02 μm to 0.5 μm, preferably 0.05 μm to 0.2 μm.

The aqueous ink or lacquer composition can further have a weight ratio of the at least one thickener, or rather the at least one associative thickener, to the at least one binder of 0.005 to 0.35, in particular 0.01 to 0.3, preferably 0.014 to 0.13. This can particularly advantageously increase the storage stability of the aqueous ink or lacquer composition. Moreover, an extremely good mechanical and chemical resistance of a dried print can be achieved using such an ink or lacquer composition.

The at least one organic solvent preferably has an evaporation number of <5000, in particular <4000, preferably <2000. In a solvent mixture, an (averaged) evaporation number of <2000 may be preferred.

The expression “evaporation number” means the volatility of the at least one organic solvent. To ascertain the evaporation number of the at least one organic solvent, in accordance with DIN 53170 the time in which the at least one solvent completely evaporates is expressed in relation to the time required for the evaporation of diethyl ether (as highly volatile reference substance). A high evaporation number means relatively slow evaporation, that is to say a low volatility, whereas a low evaporation number means a rapid evaporation, that is to say a relatively high volatility.

The at least one organic solvent as such can further have a viscosity at 25° C. of >3.5 mPas, in particular 4 mPas to 15 mPas, preferably 5 mPas to 10 mPas.

In a further configuration, the at least one organic solvent is selected from the group consisting of 3-methyl-3-methoxybutanol (MMB), methoxybutanol (MB), propylene glycol monomethyl ether (MP), glycol ether, 1-(2-hydroxyethyl)-2-pyrrolidone, N-methyl-2-pyrrolidone (NMP), N-ethylpyrrolidone (NEP), diethylene glycol monobutyl ether, diethylene glycol monoethyl ether, ethylene glycol, propylene glycol, DMSO, hexane-1,6-diol, pentane-1,5-diol, 2-pyrrolidone, glycerol, and mixtures of at least two of the organic solvents mentioned. The organic solvents described in this paragraph have proved to be particularly advantageous with respect to achieving a balanced drying time of the aqueous ink or lacquer composition and with respect to a film formation which is suitable for the coating or printing of substrates.

In a further configuration, the at least one organic solvent comprises a proportion of ≤20% by weight, in particular 10% by weight to 20% by weight, preferably 13% by weight to 18% by weight, based on the total weight of the aqueous ink or lacquer composition.

It is further preferable for the water to comprise a higher proportion, based on the total weight of the aqueous ink or lacquer composition, than the at least one organic solvent.

In a further configuration, the aqueous ink or lacquer composition comprises a water proportion of ≥50% by weight, in particular >60% by weight, preferably >70% by weight, based on the total weight of the aqueous ink or lacquer composition.

The aqueous ink or lacquer composition can additionally have a viscosity of 1 mPas to 40 mPas, in particular 2 mPas to <30 mPas, preferably 4 mPas to 15 mPas, at 20° C. and at a total solids content of <12% by weight, in particular of 3% by weight to 10% by weight, preferably 4% by weight to 9% by weight, based on the total weight of the aqueous ink or lacquer composition.

The aqueous ink or lacquer composition preferably additionally comprises at least one dye, in particular selected from the group consisting of direct dyes, acid dyes, reactive dyes, and mixtures of at least two of the dyes mentioned, and/or at least one pigment, in particular selected from the group consisting of inorganic pigments, organic pigments, hollow-sphere pigments such as polymeric hollow-sphere pigment, aluminum pigments such as coated aluminum pigments, and mixtures of at least two of the pigments mentioned.

The direct dyes and/or acid dyes and/or reactive dyes can be selected from the group consisting of Reactive Red 23, Reactive Red 180, Reactive Yellow 37, Direct Blue 86, Direct Blue 199, Direct Red 9, Direct Red 227, Direct Yellow 86, Direct Yellow 132, Direct Yellow 142, Direct Black 168, Acid Red 131, Acid Red 274, Acid Blue 198, Acid Yellow 23, Acid Black 194, and mixtures of at least two of the direct dyes and/or acid dyes and/or reactive dyes mentioned.

The inorganic pigments can be selected in particular from the group consisting of titanium dioxide, carbon black, bismuth pigments, oxides, hydroxides, Prussian blue, ultramarine, cadmium pigments, chromate pigments such as chrome yellow, chrome green or molybdates, iron oxide pigments, chromium oxide, mixed-phase oxide pigments such as Rinman's green, and mixtures of at least two of the inorganic pigments mentioned. The organic pigments can in particular be selected from the group consisting of pigments based on quinacridones, pigments based on isoindolines, pigments based on isoindolinones, pigments based on phthalocyanines, pigments based on benzimidazolones, azo pigments, monoazo pigments, diazo pigments, polycyclic pigments and mixtures of at least two of the organic pigments mentioned.

The coated aluminum pigments can, for example, have a phosphorus-containing and in particular fluorine-compound-free coating.

Use of coated aluminum pigments can make it particularly advantageously possible to provide an aqueous ink or lacquer composition having a metallic effect.

The at least one dye and/or the at least one pigment can additionally comprise a proportion of 0% by weight to 15% by weight, in particular 0.1% by weight to 15% by weight, in particular 2% by weight to 10% by weight, preferably 2.5% by weight to 7% by weight, based on the total weight of the aqueous ink or lacquer composition.

In a further configuration, the aqueous lacquer composition is pigment- and/or dye-free, in particular colorant-free.

The aqueous ink or lacquer composition can additionally comprise at least one additive, in particular selected from the group consisting of at least one pH modifier, at least one biocide, at least one wetting agent, at least one defoamer, at least one preservative, at least one film-forming assistant, and mixtures of at least two of the additives mentioned.

We also provide a method of producing an aqueous ink or lacquer composition. The method has the following steps: a) providing water and optionally at least one organic solvent, and
b) adding at least one binder and adding at least one thickener in the form of at least one associative thickener.

When carrying out step a), the water is preferably provided in the form of deionized water.

It may further be preferable that, when carrying out step b), first the at least one binder is added and then the at least one thickener.

Preferably, the at least one binder is added when carrying out step b) as a constituent of a dispersion containing at least one organic solvent and/or the at least one thickener is added as a constituent of a solution. The at least one binder can comprise a proportion here of 0.1% by weight to 10% by weight, in particular 1% by weight to 5.5% by weight, preferably 1.15% by weight to 4.6% by weight, based on the total weight of the aqueous ink or lacquer composition. The at least one thickener can comprise a proportion of 0.1% by weight to 0.5% by weight, in particular 0.03% by weight to 0.35% by weight, preferably 0.06% by weight to 0.30% by weight, based on the total weight of the aqueous ink or lacquer composition.

The method can additionally have, between step a) and step b), a step ab) of adding a pH modifier.

The method can additionally have a step c) of adding at least one additive such as, for example, at least one wetting agent and/or at least one pH modifier and/or at least one preservative and/or at least one defoamer and/or at least one film-forming assistant and/or at least one (further) organic solvent and/or at least one colorant, in particular at least one dye and/or at least one pigment. When carrying out step c), preferably first at least one further organic solvent is added and then at least one colorant, in particular at least one dye and/or at least one pigment.

The method can additionally have a step d) of further adding the at least one thickener. This can particularly advantageously achieve a final adjustment of the viscosity of the aqueous ink or lacquer composition.

With regard to further features and advantages of the method, reference is made in full to the previous description. The features and advantages described there, in particular with reference to the at least one thickener, the at least one binder, the at least one additive, and the at least one colorant, in particular the at least one dye and/or the at least one pigment, also apply analogously to the method.

We further provide a method of coating or printing, in particular digitally printing, a substrate, in particular a substrate surface, wherein a substrate, in particular the surface of a substrate, is coated or printed, in particular digitally printed, with an aqueous ink or lacquer composition.

The expression “digital printing” means a printing process in which the print image is transferred directly from a file or a data stream by a computer to a printing unit without a static printing forme being used.

The aqueous ink composition is preferably applied to the substrate, in particular to the surface of the substrate by inkjet printing. Inkjet printing is a printing process in which small droplets of liquid ink are generated and applied to the corresponding substrate. This gives, on the one hand, the possibility of generating a continuous inkjet (CIJ) or, on the other hand, the possibility of the discontinuous generation of individual droplets, which are generated and transferred to the substrate only as needed (drop-on-demand, DOD).

It may further be preferable for the aqueous ink or lacquer composition to be applied to the substrate, in particular to the surface of the substrate by single-pass printing. Single-pass printing is a printing process in which immobile printheads are arranged over the entire printing width and the substrate to be coated or printed is passed beneath the printheads. The aqueous ink or lacquer composition is preferably applied to the substrate, in particular to the surface of the substrate, in one pass. The advantage of single-pass printing consists in a high printing speed and in particular in the saving on production costs.

With regard to further features and advantages of the method, reference is made in full to the previous description. The features and advantages described there, in particular with reference to the aqueous ink or lacquer composition, also apply analogously to the method.

We still further provide a substrate that has been at least partially, in particular only partially or completely, coated or printed, in particular digitally printed, with an aqueous ink or lacquer composition.

The substrate can, for example, comprise or consist of a material selected from the group consisting of polyvinyl chloride, polymethyl methacrylate, polypropylene, polyethylene, acrylonitrile-butadiene-styrene copolymer, polystyrene, copolymers of at least two of the materials mentioned and blends, i.e., mixtures, of at least two of the materials mentioned.

The substrate is preferably a film, in particular a foodstuff packaging film. Alternatively, the substrate may be paper, a cardboard packaging or a wallpaper.

With regard to further features and advantages of the substrate, reference is made in full to the statements made within the context of our compositions and methods.

The features and advantages described there, in particular with reference to the aqueous ink or lacquer composition, also apply analogously to the substrate.

We yet further provide an ink set comprising one or more ink compositions, wherein the ink compositions differ from each other at least with respect to a colorant, in particular a dye and/or a pigment.

With regard to further features and advantages of the ink set, reference is made in full to the statements made within the context of the previous description. The features and advantages described there, in particular with reference to the aqueous ink or lacquer composition, for example, with respect to possible dyes and/or pigments, also apply analogously to the ink set.

We still further provide for the use of an aqueous ink or lacquer composition for coating and/or printing, in particular digitally printing, a substrate.

With regard to further features and advantages of the use, reference is made in full to the statements made within the context of the previous description. The features and advantages described there, in particular with reference to the aqueous ink or lacquer composition, also apply analogously to the use.

Further features and advantages emerge from the description of examples that follow. Individual features can each be implemented here alone or in combination with one another. The examples merely further elucidate the subject matter of the appended claims, without restricting this disclosure to them.

### EXAMPLES

1. Test Methods:
1.1 Printing Stability:

An ink of suitable viscosity was printed for 20 seconds using standard parameters on an appropriate printhead with a fixed, customary frequency and temperature. Nozzle tests before and after enabled an assessment of the printing stability.
1.2 Start-Up Performance:

Printing was briefly started with an appropriate printhead using an ink of suitable viscosity (nozzle test). After 30 or 60 minutes of downtime at room temperature, the nozzle test was repeated and dried-up nozzles were checked for.
1.3 Storage Stability:

The ink was stored at 50° C. for four weeks. Viscosity, surface tension and average particle size should not have changed by more than 10%.
1.4 Chemical Resistance:

A cleaning rod with sponge was soaked with a test liquid and rubbed on a dried drawdown (12 μm) of the ink being analyzed. The number of double abrasion strokes until the substrate was exposed was noted.
2. Example of an Ink Composition According to this Disclosure:

| | |
|---|---|
| Demineralized water | 58.05% |
| Monoethanolamine (pH | 0.20% |
| regulator) | |
| Joncryl 538 (binder) | 2.5% (corresponding |
| | to 1.15% solids) |
| BYK-LP-R21675 (thickener) | 1.55% (corresponding |
| | to 0.23% solids) |
| Ethyl diglycol (drying retarder) | 15% |
| Surfactant mixture | 1.1% |
| Biocide | 0.1% |
| Defoamer | 0.1% |
| Pigment dispersion | 21.4% |

The ink was printed on a Dimatix Samba G3L printhead at 24 kHz and at 32° C.

After 30 minutes of operation, no nozzle failures could be detected (ascertained on a Dropwatcher).
Start-up performance: The printhead mentioned above was restarted 40 minutes after the printing test. No missing nozzles could be detected.
Storage stability: The ink was stable over a month at 50° C. (<10% change in viscosity, surface tension, particle size).
Chemical resistance: Rubbing with isopropanol-soaked sponge: 100×.
3. Further Example of an Ink Composition According to this Disclosure

| | |
|---|---|
| Demineralized water | 48.03% |
| Monoethanolamine (pH regulator) | 0.15% |
| Joncryl 538 (binder) | 8.7% (corresponding |
| | to 4.0% solids) |
| BYK LP-R21675 (thickener) | 2.5% (corresponding |
| | to 0.38% solids) |
| 2-Pyrrolidone (drying retarder) | 5.0% |
| 3-Methyl-3-methoxy-1-butanol | 7.0% |
| (drying retarder) | |
| Butyl diglycol (drying retarder) | 6.0% |
| Surfactant mixture | 1.12% |
| Biocide | 0.1% |
| Pigment dispersion | 21.4% |

The ink was printed on a Konica-Minolta 1024i MAE printhead at 20 kHz and at 26° C. After 20 seconds of operation, no nozzle failures could be observed.
Start-up performance: The printhead mentioned above was restarted 60 minutes after the printing test. No missing nozzles could be detected.
Storage stability: The ink was stable over a month at 50° C. and 15 months at room temperature (<10% change in viscosity, surface tension, particle size).
Chemical resistance: Rubbing with isopropanol-soaked sponge: 100×.
4. Counter-Example: Formulation not According to this Disclosure (viscosity 9.5 mPas, 20° C., 511 l/s)

| | |
|---|---|
| Demineralized water | 46.28% |
| Monoethanolamine (pH regulator) | 0.1% |
| Joncryl 538 (binder) | 8.7% (corresponding |
| | to 4.0% solids) |
| Tafigel PUR 55 (thickener) | 4.3% (corresponding |
| | to 0.86% solids) |
| 2-Pyrrolidone (drying retarder) | 5.0% |
| 3-Methyl-3-methoxy-1-butanol | 7.0% |
| (drying retarder) | |
| Butyl diglycol (drying retarder) | 6.0% |
| Surfactant mixture | 1.12% |
| Biocide | 0.1% |
| Pigment dispersion | 21.4% |

The ink was printed on a Konica-Minolta 1024i MAE printhead at 20 kHz and at 26° C. After 20 seconds of operation, 90% of the nozzles had failed.
Chemical resistance: Rubbing with isopropanol-soaked sponge: 5×.
5. Further Counter-Example: Formulation not According to this Disclosure

| | |
|---|---|
| Demineralized water | 37.8% |
| Monoethanolamine (pH regulator) | 0.1% |
| Joncryl 538 (binder) | 12.9% (corresponding |
| | to 5.9% solids) |
| Tego Visko Plus 3010 (thickener) | 10.0% (corresponding |
| | to 6% solids) |
| Ethyl diglycol (drying retarder) | 15.0% |
| Surfactant mixture | 1.1% |
| Biocide | 0.1% |
| Pigment dispersion | 22.9% |

The target viscosity of 8.03 mPas (25° C., 511 l/s) could only be achieved with a thickener proportion of 6% (solids).

The ink was printed on a Konica-Minolta 1024i MAE printhead at 20 kHz and at 26° C. After 20 seconds of operation, virtually complete nozzle failure could be noted.
Chemical resistance: Rubbing with isopropanol-soaked sponge: 2×.

1-15. (canceled)

16. An aqueous ink or lacquer composition for coating or printing a substrate comprising:
at least one thickener;
at least one binder;
at least one organic solvent; and
water,
wherein the at least one thickener is at least one associative thickener, and the at least one binder is a compound different from the at least one associative thickener and is selected from the group consisting of polyacrylate, urethane acrylate, polyurethane, acrylonitrile-butadiene rubber (NBR), acrylonitrile-butadiene-styrene rubber (ABS), methacrylate-butadiene-styrene (MBS), methyl methacrylate-butadiene-styrene and mixtures thereof.

17. The aqueous ink or lacquer composition according to claim 16, wherein the viscosity of the aqueous ink or lacquer composition rises linearly with a gradient of at least two, as a proportion of the at least one associative thickener in the aqueous ink or lacquer composition increases.

18. The aqueous ink or lacquer composition according to claim 16, wherein the at least one associative thickener is selected from the group consisting of hydrophobically modified polyacrylate (HASE), hydrophobically modified cellulose ether (HEC), hydrophobically modified polyacrylamide (HMPAM), hydrophobically modified polyether (HMPE), associative polyurethane thickener and mixtures thereof.

19. The aqueous ink or lacquer composition according to claim 16, wherein the at least one associative thickener is a copolymer prepared by polymerization of an anionic monomer, a hydrophobic monomer and a non-ionic monomer.

20. The aqueous ink or lacquer composition according to claim 19, wherein
the anionic monomer is selected from the group consisting of acrylic acid, methacrylic acid, crotonic acid, phosphoethyl methacrylate, 2-acrylamido-2-methyl-1-propanesulfonic acid, sodium vinyl sulfonate, itaconic acid, fumaric acid, maleic acid, monomethyl itaconate, monomethyl fumarate, monobutyl fumarate, maleic anhydride and combinations thereof, and/or
the hydrophobic monomer is selected from the group consisting of surface-active esters, C₈-C₃₀-alkylphenoxy(ethyleneoxy)₆₋₁₀₀ethyl acrylate, C₈-C₃₀-alkylphenoxy(ethyleneoxy)₆₋₁₀₀ethyl methacrylate, C₈-C₃₀-alkoxy(ethyleneoxy)₆₋₅₀ethyl acrylate, C₈-C₃₀-alkoxy(ethyl-eneoxy)₆₋₅₀ethyl methacrylate, C₈-C₃₀-alkylphenoxyethyl acrylate, C₈-C₃₀-alkylphenoxyethyl methacrylate, C₈-C₃₀-alkoxyethyl acrylate, C₈-C₃₀-alkoxyethyl methacrylate, C₁₈H₃₇(EO)₂₀acrylate, C₁₈H₃₇(EO)₂₀ methacrylate, C₂₀H₂₅(EO)₂₃ acrylate; C₂₀H₂₅(EO)₂₃ methacrylate and combinations thereof, and/or
the non-ionic monomer is selected from the group consisting of C1- to C7-alkyl esters of acrylic acid, C1- to C7-alkyl esters of methacrylic acid, C2- to C7-hydroxyalkyl esters of acrylic acid, C2- to C7-hydroxyalkyl esters of methacrylic acid, ethyl acrylate, ethyl methacrylate, methyl acrylate, methyl methacrylate, 2-ethylhexyl acrylate, butyl acrylate, butyl methacrylate, 2-hydroxyethyl acrylate, 2-hydroxybutyl methacrylate, styrene, vinyltoluene, t-butylstyrene, isopropylstyrene, p-chlorostyrene, vinyl acetate, vinyl butyrate, vinyl caprolate, acrylonitrile, methacrylonitrile, butadiene, isoprene, vinyl chloride, vinylidene chloride and combinations thereof.

21. The aqueous ink or lacquer composition according to claim 16, wherein the at least one binder is a polyacrylate having a molar mass of ≥10 000 g/mol.

22. The aqueous ink or lacquer composition according to claim 16, wherein the at least one binder is a polyacrylate formed from an ester of acrylic acid and at least one comonomer, the ester of acrylic acid is preferably selected from the group consisting of methyl acrylate, ethyl acrylate, n-butyl acrylate, isobutyl acrylate, tert-butyl acrylate, 2-ethylhexyl acrylate, lauryl acrylate, stearyl acrylate, benzyl acrylate and combinations thereof, and/or
the at least one comonomer is preferably selected from the group consisting of methacrylic acid, methyl methacrylate, butyl acrylate, acrylamide, styrene, acrylonitrile, vinyl acetate, vinyl alcohol, urethane and combinations of at least two of the comonomers mentioned.

23. The aqueous ink or lacquer composition according to claim 16, wherein the at least one associative thickener and the at least one binder together comprise a proportion of 0.1% by weight to 10% by weight.

24. The aqueous ink or lacquer composition according to claim 16, wherein the aqueous ink or lacquer composition has a ratio of the at least one binder to the at least one associative thickener of at least 5:1, based on the combined solids contents of the at least one binder and the at least one associative thickener present in the aqueous ink or lacquer composition.

25. The aqueous ink or lacquer composition according to claim 16, wherein the at least one organic solvent is selected from the group consisting of 3-methyl-3-methoxybutanol (MMB), methoxybutanol (MB), propylene glycol monomethyl ether (MP), glycol ether,
1-(2-hydroxyethyl)-2-pyrrolidone, N-methyl-2-pyrrolidone (NMP), N-ethylpyrrolidone (NEP), diethylene glycol monobutyl ether, diethylene glycol monoethyl ether, ethylene glycol, propylene glycol, DMSO, hexane-1,6-diol, pentane-1,5-diol, 2-pyrrolidone, glycerol and mixtures thereof.

26. The aqueous ink or lacquer composition according to claim 16, wherein the at least one organic solvent comprises a proportion of ≤20% by weight, based on the total weight of the ink or lacquer composition.

27. The aqueous ink or lacquer composition according to claim 16, wherein the water comprises a proportion of ≥50% by weight, based on the total weight of the ink or lacquer composition.

28. A method of coating, printing or digitally printing a substrate comprising coating, printing or digitally printing a surface of a substrate with the aqueous ink or lacquer composition according to claim 16.

29. A substrate at least partially coated, printed or digitally printed with the aqueous ink or lacquer composition according to claim 16.

30. An ink set comprising one or more of the ink compositions according to claim 16, wherein the ink compositions differ from each other at least with respect to a colorant, a dye and/or a pigment.
